(19) United States
(12) Patent Application Publication
(10) Pub. No.: US 2014/0326363 A1
(43) Pub. Date: Nov. 6, 2014

(54) R-T-B-BASED RARE EARTH MAGNET PARTICLES, PROCESS FOR PRODUCING THE R-T-B-BASED RARE EARTH MAGNET PARTICLES, AND BONDED MAGNET

(71) Applicants: Nobuhiro Katayama, Otake-shi (JP); Hirofumi Kawasaki, Otake-shi (JP); Koichiro Morimoto, Otake-shi (JP)

(72) Inventors: Nobuhiro Katayama, Otake-shi (JP); Hirofumi Kawasaki, Otake-shi (JP); Koichiro Morimoto, Otake-shi (JP)

(73) Assignee: TODA KOGYO CORP., Otake-shi, Hiroshima-ken (JP)

(21) Appl. No.: 14/342,930

(22) PCT Filed: Aug. 30, 2012
(86) PCT No.: PCT/JP2012/072060

§ 371 Date: May 22, 2014

(30) Foreign Application Priority Data
Sep. 9, 2011 (JP) 2011-196988
Dec. 2, 2011 (JP) 2011-265321

(51) Int. Cl. H01F 1/057; H01F 41/02

(52) U.S. Cl. CPC H01F 1/0571; H01F 1/0576; H01F 41/0266
USPC 148/105; 148/302; 75/246

(57) ABSTRACT

The present invention provides R-T-B-based rare earth magnet particles comprising no expensive rare resources such as Dy and having an excellent coercive force which can be produced by HDDR treatment without any additional steps. The present invention relates to R-T-B-based rare earth magnet particles comprising crystal grains comprising a magnetic phase of R₂T₁₄B, and a grain boundary phase, in which the grain boundary phase has a composition comprising R in an amount of not less than 13.5 atom % and not more than 35.0 atom % and Al in an amount of not less than 1.0 atom % and not more than 7.0 atom %. The R-T-B-based rare earth magnet particles can be obtained by controlling heat treatment conditions in the DR step of the HDDR treatment in the course of subjecting a raw material alloy to the HDDR treatment.

### TECHNICAL FIELD

The present invention relates to R-T-B-based rare earth magnet particles, and a process for producing the R-T-B-based rare earth magnet particles.

### BACKGROUND OF THE INVENTION

R-T-B-based rare earth magnet particles have excellent magnetic properties and have been extensively used in the industrial applications such as magnets for various motors employed in automobiles, etc. However, the R-T-B-based rare earth magnet particles tend to suffer from a large change in magnetic properties depending upon a temperature, and therefore tends to be rapidly deteriorated in coercive force under a high-temperature condition. For this reason, it has been required to previously produce magnet particles having a high coercive force to ensure a high coercive force thereof even under a high-temperature condition. In order to enhance a coercive force of the magnet particles, it is necessary to form a grain boundary phase having a lower magnetization degree than that of crystal grains as a main phase in order to weaken a magnetic bond between the crystal grains.

In Patent Document 1, it is described that an R-T-B-based alloy to which a trace amount of Dy is added is subjected to HDDR treatment (hydrogenation-decomposition-desorption-recombination) to obtain magnet particles having an excellent coercive force.

In Patent Document 2, it is described that diffusing particles comprising a hydride of Dy or the like are mixed in RFeBHₓ particles, and the resulting mixed particles are subjected to diffusion heat treatment step and dehydrogenation step to thereby obtain magnet particles having an excellent coercive force which comprise Dy or the like diffused on a surface of the particles and inside thereof.

In Patent Document 3, it is described that Zn-containing particles are mixed in R—Fe—B-based magnet particles produced by HDDR treatment, and the resulting mixed particles are subjected to mixing and pulverization, diffusion heat treatment and aging heat treatment to thereby obtain magnet particles having an excellent coercive force which comprise Zn diffused in a grain boundary thereof.

In addition, in Patent Document 4, it is described that Nd—Cu particles are mixed in R—Fe—B-based magnet particles produced by HDDR treatment, and the resulting mixed particles are subjected to heat treatment and diffusion to diffuse Nd—Cu in a grain boundary thereof as a main phase to obtain magnet particles having an excellent coercive force.

### CITATION LIST

### Patent Literature

Patent Document 1: Japanese Patent Application Laid-Open (KOKAI) No. 9-165601
Patent Document 2: Japanese Patent Application Laid-Open (KOKAI) No. 2002-09610
Patent Document 3: Japanese Patent Application Laid-Open (KOKAI) No. 2011-49441
Patent Document 4: PCT Pamphlet WO 2011/145674

### SUMMARY OF THE INVENTION

### Problem to be Solved by the Invention

Hitherto, various studies have been made to enhance a coercive force of magnet particles by a method of adding Dy to a raw material alloy or a method of diffusing additive elements in the raw material alloy during HDDR step or after HDDR step. However, the rare earth elements such as Dy or a hydride thereof as described in Patent Documents 1 and 2 which are used for enhancing a coercive force of the magnet particles are expensive rare sources. In addition, the methods described in Patent Documents 2, 3 and 4 require, in addition to the HDDR step, various additional steps such as a step of controlling amounts of the additive elements, a step of mixing particles of the additive elements with the HDDR particles, a diffusion heat treatment step or the like, and therefore tends to be complicated, resulting in poor productivity. In the method as described in Patent Document 1 in which Dy is added to the raw material alloy, although it is not required to conduct any additional step, there tends to arise such a problem that the resulting R-T-B-based rare earth magnet particles tend to be deteriorated in residual magnetic flux density owing to inclusion of Dy even in Nd₂Fe₁₄B as a main phase.

An object of the present invention is to obtain R-T-B-based rare earth magnet particles having an excellent coercive force by controlling contents of R and Al in a grain boundary phase thereof without using the above-mentioned expensive rare resources such as Dy. In addition, a further object of the present invention is to obtain R-T-B-based rare earth magnet particles having an excellent coercive force only by HDDR step without conducting additional steps for diffusing the R element in a grain boundary thereof and enhancing a coercive force thereof, such as a step of adding various elements thereto during or after the HDDR step and a diffusion heat treatment step.

### Means for the Solution of the Subject

That is, according to the present invention, there are provided R-T-B-based rare earth magnet particles comprising R (wherein R represents at least one rare earth element including Y), T (wherein T represents Fe, or Fe and Co), B (wherein B represents boron) and Al (wherein Al represents aluminum), and having an average composition comprising R in an amount of not less than 12.5 atom % and not more than 17.0 atom %, B in an amount of not less than 4.5 atom % and not more than 7.5 atom % and Al in an amount of not less than 1.0 atom % and not more than 5.0 atom %, in which the R-T-B-based rare earth magnet particles comprise crystal grains comprising a magnetic phase of R₂T₁₄B, and a grain boundary phase, and the grain boundary phase comprises R (wherein R represents at least one rare earth element including Y), T (wherein T represents Fe, or Fe and Co), B (wherein B represents boron) and Al (wherein Al represents aluminum), and has a composition comprising R in an amount of not less than 13.5 atom % and not more than 35.0 atom % and Al in an amount of not less than 1.0 atom % and not more than 7.0 atom % (Invention 1).

Also, according to the present invention, there are provided the R-T-B-based rare earth magnet particles as described in the above Invention 1, wherein the R-T-B-based rare earth magnet particles comprise Ga and Zr, and have a composition comprising Co in an amount of not more than 15.0 atom %, Ga in an amount of not less than 0.1 atom % and not more than 0.6 atom % and Zr in an amount of not less than 0.05 atom % and not more than 0.15 atom % (Invention 2).

Further, according to the present invention, there is provided a process for producing R-T-B-based rare earth magnet particles by HDDR treatment, in which a raw material alloy for the R-T-B-based rare earth magnet particles comprises R (wherein R represents at least one rare earth element including Y), T (wherein T represents Fe, or Fe and Co), B (wherein B represents boron) and Al (wherein Al represents aluminum), and has a composition comprising R in an amount of not less than 12.5 atom % and not more than 17.0 atom %, B in an amount of not less than 4.5 atom % and not more than 7.5 atom %, and Al in such an amount that a proportion of Al relative to R satisfies a requirement that a value of Al (atom %)/{(R (atom %)−12)+Al (atom %)} falls with the range of 0.40 to 0.75; the DR step of the HDDR treatment is conducted at a treating temperature of 650 to 900° C.; and a retention time of an evacuation step in the DR step at a vacuum degree of not less than 1 Pa and not more than 2000 Pa is not less than 10 min and not more than 300 min, the vacuum degree to be finally reached being not more than 1 Pa (Invention 3).

Also, according to the present invention, there is provided the process for producing R-T-B-based rare earth magnet particles as described in the above invention 3, wherein the raw material alloy comprises Ga and Zr, and has a composition comprising Co in an amount of not more than 15.0 atom %, Ga in an amount of not less than 0.1 atom % and not more than 0.6 atom % and Zr in an amount of not less than 0.05 atom % and not more than 0.15 atom % (Invention 4).

In addition, according to the present invention, there is provided a bonded magnet comprising the R-T-B-based rare earth magnet particles as described in the above Invention 1 or 2 (Invention 5).

### Effect of the Invention

In accordance with the present invention, by controlling contents of R and Al in a grain boundary phase, it is possible to form a continuous grain boundary phase at a boundary of crystal grains and thereby obtain R-T-B-based rare earth magnet particles having an excellent coercive force. Further, according to the present invention, the R-T-B-based rare earth magnet particles having an excellent coercive force can be produced without using any expensive rare resources such as Dy and conducting any additional steps other than the HDDR step.

### BRIEF DESCRIPTION OF THE DRAWING

FIG. 1 is an electron micrograph of Nd—Fe—B-based rare earth magnet particles obtained in Example 1.

### PREFERRED EMBODIMENTS FOR CARRYING OUT THE INVENTION

First, the R-T-B-based rare earth magnet particles according to the present invention are described.

The R-T-B-based rare earth magnet particles according to the present invention comprise R (wherein R represents at least one rare earth element including Y), T (wherein T represents Fe, or Fe and Co), B (wherein B represents boron) and Al (wherein Al represents aluminum).

As the rare earth element R constituting the R-T-B-based rare earth magnet particles according to the present invention, there may be used at least one element selected from the group consisting of Y, La, Ce, Pr, Nd, Pm, Sm, Eu, Gd, Tb, Ho, Er, Tm, Yb and Lu. Among these rare earth elements, from the standpoint of costs and magnetic properties, Nd is preferably used. The R-T-B-based rare earth magnet particles have an average composition comprising R in an amount of not less than 12.5 atom % and not more than 17.0 atom %. When the average composition of the magnet particles comprises R in an amount of less than 12.5 atom %, the content of R in a composition of the grain boundary phase tends to be less than 13.5 atom %, so that it is not possible to attain a sufficient effect of enhancing a coercive force of the resulting magnet particles. When the average composition of the magnet particles comprises R in an amount of more than 17.0 atom %, the content of the grain boundary phase having a low magnetization in the magnet particles tends to be increased, so that the resulting magnet particles tend to be deteriorated in residual magnetic flux density. The content of R in the average composition of the magnet particles is preferably not less than 12.5 atom % and not more than 16.5 atom %, more preferably not less than 12.5 atom % and not more than 16.0 atom %, still more preferably not less than 12.8 atom % and not more than 15.0 atom %, and further still more preferably not less than 12.8 atom % and not more than 14.0 atom %.

The element T constituting the R-T-B-based rare earth magnet particles according to the present invention is Fe, or Fe and Co. The content of the element T in the average composition of the magnet particles is the balance of the composition of the magnet particles except for the other elements constituting the magnet particles. In addition, when Co is added as an element with which Fe is to be substituted, it is possible to raise a Curie temperature of the magnet particles. However, the addition of Co to the magnet particles tends to induce deterioration in residual flux density of the resulting particles. Therefore, the content of Co in the average composition of the magnet particles is preferably controlled to not more than 15.0 atom %.

The content of B in the average composition of the R-T-B-based rare earth magnet particles according to the present invention is not less than 4.5 atom % and not more than 7.5 atom %. When the content of B in the average composition of the magnet particles is less than 4.5 atom %, an R₂T₁₇ phase and the like tend to be precipitated, so that the resulting magnet particles tend to be deteriorated in magnetic properties. When the content of B in the average composition of the magnet particles is more than 7.5 atom %, the resulting magnet particles tend to be deteriorated in residual magnetic flux density. The content of B in the average composition of the magnet particles is preferably not less than 5.0 atom % and not more than 7.0 atom %.

The content of Al in the average composition of the R-T-B-based rare earth magnet particles according to the present invention is not less than 1.0 atom % and not more than 5.0 atom %. In the present invention, it is considered that Al has the effect of uniformly diffusing a surplus amount of R in a grain boundary of the R-T-B-based rare earth magnet particles. When the content of Al in the average composition of the magnet particles is less than 1.0 atom %, diffusion of R in the grain boundary tends to be insufficient. When the content of Al in the average composition of the magnet particles is more than 5.0 atom %, the amount of the grain boundary phase having a low magnetization tends to be increased, so that the resulting magnet particles tend to be deteriorated in residual magnetic flux density. The content of Al in the average composition of the magnet particles is preferably not less than 1.2 atom % and not more than 4.5 atom %, more preferably not less than 1.4 atom % and not more than 3.5 atom %, and still more preferably not less than 1.5 atom % and not more than 2.5 atom %.

In addition, the R-T-B-based rare earth magnet particles according to the present invention preferably comprise Ga and Zr. The content of Ga in the average composition of the magnet particles is preferably not less than 0.1 atom % and not more than 0.6 atom %. When the content of Ga in the average composition of the magnet particles is less than 0.1 atom %, the effect of enhancing a coercive force of the resulting magnet particles tends to be low. When the content of Ga in the average composition of the magnet particles is more than 0.6 atom %, the resulting magnet particles tend to be deteriorated in residual magnetic flux density. Also, the content of Zr in the average composition of the magnet particles is preferably not less than 0.05 atom % and not more than 0.15 atom %. When the content of Zr in the average composition of the magnet particles is less than 0.05 atom %, the effect of enhancing a residual magnetic flux density of the resulting magnet particles tends to be low. When the content of Zr in the average composition of the magnet particles is more than 0.15 atom %, the resulting magnet particles tend to be deteriorated in residual magnetic flux density.

Further, the R-T-B-based rare earth magnet particles according to the present invention may also comprise, in addition to the above-mentioned elements, at least one element selected from the group consisting of Ti, V, Nb, Cu, Si, Cr, Mn, Zn, Mo, Hf, W, Ta and Sn. When adding these elements to the magnet particles, it is possible to enhance magnetic properties of the resulting R-T-B-based rare earth magnet particles. The total content of these elements in the magnet particles is preferably not more than 2.0 atom %. When the total content of these elements in the magnet particles is more than 2.0 atom %, the resulting magnet particles tend to be deteriorated in residual magnetic flux density.

The R-T-B-based rare earth magnet particles according to the present invention comprise crystal grains comprising an R₂T₁₄B magnetic phase, and a grain boundary phase. In the R-T-B-based rare earth magnet particles according to the present invention, a continuous grain boundary phase is present in an interface between the crystal grains. Therefore, it is considered that since a magnetic bond between the crystal grains can be weakened, the resulting magnet particles can exhibit a high coercive force.

The grain boundary phase of the R-T-B-based rare earth magnet particles according to the present invention comprises R (wherein R represents at least one rare earth element including Y), T (wherein T represents Fe, or Fe and Co), B (wherein B represents boron) and Al (wherein Al represents aluminum).

The content of R in the composition of the grain boundary phase of the R-T-B-based rare earth magnet particles according to the present invention is not less than 13.5 atom % and not more than 35.0 atom %. When the content of R in the composition of the grain boundary phase is less than 13.5 atom %, it is not possible to attain a sufficient effect of enhancing a coercive force of the magnet particles. When the content of R in the composition of the grain boundary phase is more than 35.0 atom %, magnetization of a grain boundary of the magnet particles tends to be lowered, so that the resulting magnet particles tend to be deteriorated in residual magnetic flux density. The content of R in the composition of the grain boundary phase of the magnet particles is preferably not less than 18.0 atom % and not more than 33.0 atom %, and more preferably not less than 20.0 atom % and not more than 30.0 atom %.

The content of Al in the composition of the grain boundary phase of the R-T-B-based rare earth magnet particles according to the present invention is not less than 1.0 atom % and not more than 7.0 atom %. When the content of Al in the composition of the grain boundary phase is less than 1.0 atom %, diffusion of R in the grain boundary tends to be insufficient. When the content of Al in the composition of the grain boundary phase is more than 7.0 atom %, magnetization of the grain boundary tends to be lowered, so that the resulting magnet particles tend to be deteriorated in residual magnetic flux density. The content of Al in the composition of the grain boundary phase of the magnet particles is preferably not less than 1.2 atom % and not more than 6.0 atom %, more preferably not less than 1.2 atom % and not more than 5.0 atom %, and still more preferably not less than 1.5 atom % and not more than 4.0 atom %.

The element T constituting the grain boundary phase of the R-T-B-based rare earth magnet particles according to the present invention is Fe, or Fe and Co. The content of the element T in the composition of the grain boundary phase of the magnet particles is the balance of the composition of the grain boundary phase of the magnet particles except for the other elements constituting the grain boundary phase.

Further, the grain boundary phase of the R-T-B-based rare earth magnet particles according to the present invention may also comprise, in addition to the above-mentioned elements, at least one element selected from the group consisting of Ga, Zr, Ti, V, Nb, Cu, Si, Cr, Mn, Zn, Mo, Hf, W, Ta and Sn.

The R-T-B-based rare earth magnet particles according to the present invention have excellent magnetic properties. The coercive force (H_{cj}) of the R-T-B-based rare earth magnet particles is usually not less than 1100 kA/m, and preferably not less than 1300 kA/m. The maximum energy product (BHₘₐₓ) of the R-T-B-based rare earth magnet particles is usually not less than 195 kJ/m³, and preferably not less than 220 kJ/m³. The residual magnetic flux density (Bᵣ) of the R-T-B-based rare earth magnet particles is usually not less than 1.05 T, and preferably not less than 1.10 T.

In the following, the process for producing the R-T-B-based rare earth magnet particles according to the present invention is described in detail. In the process for producing the R-T-B-based rare earth magnet particles according to the present invention, the raw material alloy is subjected to HDDR treatment, and the resulting particles are cooled to obtain the R-T-B-based rare earth magnet particles.

First, the raw material alloy for the R-T-B-based rare earth magnet particles according to the present invention is explained.

The raw material alloy for the R-T-B-based rare earth magnet particles according to the present invention comprises R (wherein R represents at least one rare earth element including Y), T (wherein T represents Fe, or Fe and Co), B (wherein B represents boron) and Al (wherein Al represents aluminum).

As the rare earth element R constituting the raw material alloy for the R-T-B-based rare earth magnet particles according to the present invention, there may be used at least one element selected from the group consisting of Y, La, Ce, Pr, Nd, Pm, Sm, Eu, Gd, Tb, Ho, Er, Tm, Yb and Lu. Among these rare earth elements, from the standpoint of costs and magnetic properties, Nd is preferably used. The content of the element R in the raw material alloy is not less than 12.5 atom % and not more than 17.0 atom %. When the content of the element R in the raw material alloy is less than 12.5 atom %, a surplus amount of R diffused in the grain boundary tends to be reduced, so that it is not possible to attain a sufficient effect of enhancing a coercive force of the resulting magnet particles. When the content of the element R in the raw material alloy is more than 17.0 atom %, the amount of the grain boundary phase having a low magnetization tends to be increased so that the resulting magnet particles tend to be deteriorated in residual magnetic flux density. The content of the element R in the raw material alloy is preferably not less than 12.5 atom % and not more than 16.5 atom %, more preferably not less than 12.5 atom % and not more than 16.0 atom %, still more preferably not less than 12.8 atom % and not more than 15.0 atom %, and further still more preferably not less than 12.8 atom % and not more than 14.0 atom %.

The element T constituting the raw material alloy for the R-T-B-based rare earth magnet particles according to the present invention is Fe, or Fe and Co. The content of the element T in the raw material alloy is the balance of the composition of the raw material alloy except for the other elements constituting the raw material alloy. In addition, when Co is added as an element with which Fe is to be substituted, it is possible to raise a Curie temperature of the raw material alloy. However, the addition of Co to the raw material alloy tends to induce deterioration in residual flux density of the resulting R-T-B-based rare earth magnet particles. Therefore, the content of Co in the raw material alloy is preferably controlled to not more than 15.0 atom %.

The content of B in the raw material alloy for the R-T-B-based rare earth magnet particles according to the present invention is not less than 4.5 atom % and not more than 7.5 atom %. When the content of B in the raw material alloy is less than 4.5 atom %, an R₂T₁₇ phase and the like tend to be precipitated, so that the resulting magnet particles tend to be deteriorated in magnetic properties. When the content of B in the raw material alloy is more than 7.5 atom %, the resulting R-T-B-based rare earth magnet particles tend to be deteriorated in residual magnetic flux density. The content of B in the raw material alloy is preferably not less than 5.0 atom % and not more than 7.0 atom %.

The content of Al in the raw material alloy of the R-T-B-based rare earth magnet particles according to the present invention is controlled such that the proportion of Al relative to R satisfy such a requirement that a value of Al (atom %)/{(R (atom %)−12)+Al (atom %)} falls with the range of 0.40 to 0.75. In the present invention, it is considered that Al has the effect of uniformly diffusing a surplus amount of R in a grain boundary of the R-T-B-based rare earth magnet particles. For example, in the case where Nd is used as R, the eutectic reaction between Nd and Al is caused at a temperature of about 630° C. Therefore, there is a possibility that a liquid phase of Nd—Al is formed during the HDDR treatment. It is considered that the liquid phase has the effect of uniformly diffusing a surplus amount of Nd in the grain boundary in the complete evacuation step. When the value of Al (atom %)/{(R (atom %)−12)+Al (atom %)} is less than 0.40, uniform diffusion of Nd tends to hardly proceed. When the value of Al (atom %)/{(R (atom %)−12)+Al (atom %)} is more than 0.75, the amount of the grain boundary phase having a low magnetization in the obtained R-T-B-based rare earth magnet particles tends to be increased, so that the resulting magnet particles tend to be deteriorated in residual magnetic flux density. The value of Al (atom %)/{(R (atom %)−12)+Al (atom %)} is preferably 0.45 to 0.70.

Further, the raw material alloy for the R-T-B-based rare earth magnet particles according to the present invention preferably comprises Ga and Zr. The content of Ga in the raw material alloy is preferably not less than 0.1 atom % and not more than 0.6 atom %. When the content of Ga in the raw material alloy is less than 0.1 atom %, the effect of enhancing a coercive force of the resulting magnet particles tends to be low. When the content of Ga in the raw material alloy is more than 0.6 atom %, the resulting R-T-B-based rare earth magnet particles tend to be deteriorated in residual magnetic flux density. In addition, the content of Zr in the raw material alloy is preferably not less than 0.05 atom % and not more than 0.15 atom %. When the content of Zr in the raw material alloy is less than 0.05 atom %, the effect of enhancing a residual magnetic flux density of the resulting magnet particles tends to be low. When the content of Zr in the raw material alloy is more than 0.15 atom %, the resulting R-T-B-based rare earth magnet particles tend to be deteriorated in residual magnetic flux density.

In addition, the raw material alloy for the R-T-B-based rare earth magnet particles according to the present invention may also comprise, in addition to the above-mentioned elements, at least one element selected from the group consisting of Ti, V, Nb, Cu, Si, Cr, Mn, Zn, Mo, Hf, W, Ta and Sn. When adding these elements to the raw material alloy, it is possible to enhance magnetic properties of the resulting R-T-B-based rare earth magnet particles. The total content of these elements in the raw material alloy is preferably not more than 2.0 atom %. When the total content of these elements in the raw material alloy is more than 2.0 atom %, the resulting magnet particles tend to be deteriorated in residual magnetic flux density or suffer from precipitation of the other phases.

### (Production of Raw Material Alloy Particles)

As the raw material alloy for the R-T-B-based rare earth magnet particles, there may be used ingots produced by a book mold casting method or a centrifugal casting method, or strips produced by a strip casting method. These alloys tend to undergo segregation of their composition upon the casting, and therefore may be subjected to homogenization heat treatment for formation of the uniform composition before subjected to the HDDR treatment. The homogenization heat treatment may be carried out in a vacuum atmosphere or in an inert gas atmosphere at a temperature of preferably not lower than 950° C. and not higher than 1200° C. and more preferably not lower than 1000° C. and not higher than 1170° C. Next, the raw material alloy is subjected to coarse pulverization and fine pulverization to thereby produce raw material alloy particles for the HDDR treatment. The coarse pulverization may be carried out using a jaw crusher or the like. Thereafter, the resulting particles may be subjected to ordinary hydrogen absorbing pulverization and mechanical pulverization to thereby produce raw material alloy particles for the R-T-B-based rare earth magnet particles.

Next, the process for producing the R-T-B-based rare earth magnet particles using the above raw material alloy particles is explained.

### (HDDR Treatment)

The HDDR treatment includes an HD step in which an R-T-B-based raw material alloy is subjected to hydrogenation to decompose the alloy into an α-Fe phase, an RH₂ phase and an Fe₂B phase, and a DR step in which hydrogen is discharged under reduced pressure so that a reverse reaction of the above step is caused to produce Nd₂Fe₁₄B from the above respective phases. The evacuation step of the DR step includes a preliminary evacuation step and a complete evacuation step.

### (HD Step)

The HD step is preferably carried out at a treating temperature of not lower than 700° C. and not higher than 870° C. The reason why the treating temperature is adjusted to not lower than 700° C. is that when the treating temperature is lower than 700° C., the reaction may fail to proceed. Also, the reason why the treating temperature is adjusted to not higher than 870° C. is that when the treating temperature is higher than 870° C., growth of crystal grains tends to be caused, so that the resulting magnet particles tend to be deteriorated in coercive force. The atmosphere used in the HD step is preferably a mixed gas atmosphere of a hydrogen gas and an inert gas having a hydrogen partial pressure of not less than 20 kPa and not more than 90 kPa. The hydrogen partial pressure in the mixed gas atmosphere is more preferably not less than 40 kPa and not more than 80 kPa. The reason therefor is as follows. That is, when the hydrogen partial pressure is less than 20 kPa, the reaction tends to hardly proceed, whereas when the hydrogen partial pressure is more than 90 kPa, the reactivity tends to become excessively high, so that the resulting magnet particles tend to be deteriorated in magnetic properties. The treating time of the HD step is preferably not less than 30 min and not more than 10 hr, and more preferably not less than 1 hr and not more than 7 hr.

### (DR Step: Preliminary Evacuation Step)

The preliminary evacuation step is conducted at a treating temperature of not lower than 800° C. and not higher than 900° C. The reason why the treating temperature is adjusted to not lower than 800° C. is that when the treating temperature is lower than 800° C., the dehydrogenation tends to hardly proceed. Whereas, the reason why the treating temperature is adjusted to not higher than 900° C. is that when the treating temperature is higher than 900° C., the resulting particles tends to be deteriorated in coercive force owing to excessive growth of crystal grains therein. In the preliminary evacuation step, the vacuum degree is preferably adjusted to not less than 2.5 kPa and not more than 4.0 kPa. The reason therefor is that it is required to remove hydrogen from an RH₂ phase. When removing hydrogen from the RH₂ phase in the preliminary evacuation step, it is possible to obtain an RFeBH phase having a uniform crystal orientation. The treating time of the preliminary evacuation step is preferably not less than 30 min and not more than 180 min.

### (DR Step: Complete Evacuation Step)

The complete evacuation step is preferably conducted at a treating temperature of not lower than 650° C. and not higher than 900° C. The reason why the treating temperature is adjusted to not lower than 650° C. is that when the treating temperature is lower than 650° C., no dehydrogenation tends to proceed, so that the resulting magnet particles tend to be hardly improved in coercive force. On the other hand, the reason why the treating temperature is adjusted to not higher than 900° C. is that when the treating temperature is higher than 900° C., the resulting magnet particles tends to be deteriorated in coercive force owing to excessive growth of crystal grains therein. The treating temperature of the complete evacuation step is more preferably not lower than 700° C. and not higher than 850° C.

In the complete evacuation step, the atmosphere used in the preliminary evacuation step is subjected to further evacuation until finally reaching a vacuum degree of not more than 1 Pa. In addition, the total treating time of the complete evacuation step is adjusted to not less than 30 min and not more than 330 min, in particular, the retention time at a vacuum degree of not less than 1 Pa and not more than 2000 Pa is adjusted to not less than 10 min and not more than 300 min. The total treating time of the complete evacuation step is preferably not less than 80 min and not more than 330 min, and more preferably not less than 100 min and not more than 330 min. The retention time at a vacuum degree of not less than 1 Pa and not more than 2000 Pa is preferably not less than 15 min and not more than 300 min, more preferably not less than 40 min and not more than 280 min, and still more preferably not less than 60 min and not more than 280 min. The vacuum degree in the complete evacuation step may be decreased either continuously or stepwise. When the total treating time of the complete evacuation step is less than 30 min, the dehydrogenation tends to be incomplete, so that the resulting magnet particles tend to be deteriorated in coercive force. When the total treating time of the complete evacuation step is more than 330 min, excessive growth of crystal grains tends to be caused, so that the resulting magnet particles tend to be deteriorated in coercive force.

In the present invention, it is considered that when the particles are held for a long period of time at a vacuum degree of not more than 2000 Pa in which hydrogen is dissociated from the R-rich phase at a temperature at which the R—Al liquid phase is present during the DR step, uniform diffusion of the R-rich phase into the R₂T₁₄B main phase is promoted, so that the resulting magnet particles can be enhanced in coercive force.

The complete evacuation step may be conducted at a treating temperature of not lower than 800° C. and not higher than 900° C. similarly to the preliminary evacuation step. In this case, the total treating time of the complete evacuation step is adjusted to not less than 30 min and not more than 150 min, in particular, the retention time at a vacuum degree of not less than 1 Pa and not more than 2000 Pa is preferably adjusted to not less than 10 min and not more than 140 min, and more preferably not less than 15 min and not more than 120 min. Although the total treating time of the complete evacuation step may be more than 150 min, a further effect of enhancing a coercive force of the magnet particles is no longer attained.

When the treating time of the complete evacuation step is not lower than 800° C. and not higher than 900° C., it is preferred that the content of R in the raw material alloy for the R-T-B-based rare earth magnet particles according to the present invention is not less than 12.5 atom % and not more than 14.3 atom %, and the content of Al in the raw material alloy is controlled such that the proportion of Al relative to R satisfies the requirement that the value of Al (atom %)/{(R (atom %)−12)+Al (atom %)} is in the range of 0.40 to 0.75. It is more preferred that the content of R in the raw material alloy is not less than 12.8 atom % and not more than 14.0 atom %, and the content of Al in the raw material alloy is controlled such that the proportion of Al relative to R satisfies the requirement that the value of Al (atom %)/{(R (atom %)−12)+Al (atom %)} is in the range of 0.45 to 0.70.

In the above case, the content of R in the average composition of the R-T-B-based rare earth magnet particles according to the present invention is not less than 12.5 atom % and not more than 14.3 atom %, and more preferably not less than 12.8 atom % and not more than 14.0 atom %.

In the above case, the content of Al in the average composition of the R-T-B-based rare earth magnet particles according to the present invention is not less than 1.0 atom % and not more than 3.0 atom %, and more preferably not less than 1.5 atom % and not more than 2.5 atom %.

Also, in the above case, it is preferred that the content of R in the composition of the grain boundary phase of the R-T-B-based rare earth magnet particles according to the present invention is not less than 13.5 atom % and not more than 30.0 atom %, and the content of Al in the composition of the grain boundary phase is not less than 1.0 atom % and not more than 5.0 atom %. It is more preferred that the content of R in the composition of the grain boundary phase is not less than 20.0 atom % and not more than 30.0 atom %, and the content of Al in the composition of the grain boundary phase is not less than 1.5 atom % and not more than 4.0 atom %.

The complete evacuation step may be conducted at a treating temperature of not lower than 650° C. and not higher than 800° C. In this case, it is preferred that the total treating time of the complete evacuation step is adjusted to not less than 80 min and not more than 330 min, in particular, the retention time at a vacuum degree of not less than 1 Pa and not more than 2000 Pa is adjusted to not less than 60 min and not more than 300 min in order to enhance a coercive force of the resulting magnet particles. It is more preferred that the total treating time of the complete evacuation step is not less than 100 min and not more than 330 min, and the retention time at a vacuum degree of not less than 1 Pa and not more than 2000 Pa is not less than 80 min and not more than 300 min. It is still more preferred that the total treating time of the complete evacuation step is not less than 140 min and not more than 330 min, and the retention time at a vacuum degree of not less than 1 Pa and not more than 2000 Pa is not less than 100 min and not more than 280 min.

When the treating temperature of the complete evacuation step is adjusted to not lower than 650° C. and not higher than 800° C. and the total treating time of the complete evacuation step is adjusted to not less than 80 min and not more than 330 min, it is preferred that the content of R in the raw material alloy for the R-T-B-based rare earth magnet particles according to the present invention is not less than 12.5 atom % and not more than 17.0 atom %, and the content of Al in the raw material alloy is controlled such that the proportion of Al relative to R satisfies the requirement that the value of Al (atom %)/{(R (atom %)−12)+Al (atom %)} is in the range of 0.40 to 0.75. It is more preferred that the content of R in the raw material alloy is not less than 12.8 atom % and not more than 16.5 atom %, and the content of Al in the raw material alloy is controlled such that the proportion of Al relative to R satisfies the requirement that the value of Al (atom %)/{(R (atom %)−12)+Al (atom %)} is in the range of 0.45 to 0.70.

In the above case, the content of R in the average composition of the R-T-B-based rare earth magnet particles according to the present invention is not less than 12.5 atom % and not more than 17.0 atom %, and more preferably not less than 12.8 atom % and not more than 16.5 atom %.

In the above case, the content of Al in the average composition of the R-T-B-based rare earth magnet particles according to the present invention is not less than 1.0 atom % and not more than 5.0 atom %, and more preferably not less than 1.5 atom % and not more than 4.5 atom %.

Also, in the above case, it is preferred that the content of R in the raw material alloy for the R-T-B-based rare earth magnet particles according to the present invention is not less than 12.5 atom % and not more than 17.0 atom %, and the content of Al in the raw material alloy is controlled such that the proportion of Al relative to R satisfies the requirement that the value of Al (atom %)/{(R (atom %)−12)+Al (atom %)} is in the range of 0.40 to 0.75. It is more preferred that the content of R in the raw material alloy is not less than 12.8 atom % and not more than 16.5 atom %, and the content of Al in the raw material alloy is controlled such that the proportion of Al relative to R satisfies the requirement that the value of Al (atom %)/{(R (atom %)−12)+Al (atom %)} is in the range of 0.45 to 0.70.

When the treating temperature of the complete evacuation step is adjusted to not lower than 650° C. and not higher than 800° C. and the total treating time of the complete evacuation step is adjusted to not less than 80 min and not more than 330 min, it is more preferred that the content of R in the raw material alloy for the R-T-B-based rare earth magnet particles according to the present invention is not less than 13.8 atom % and not more than 17.0 atom %, and the content of Al in the raw material alloy is controlled such that the proportion of Al relative to R satisfies the requirement that the value of Al (atom %)/{(R (atom %)−12)+Al (atom %)} is in the range of 0.40 to 0.75. It is still more preferred that the content of R in the raw material alloy is not less than 14.0 atom % and not more than 16.5 atom %, and the content of Al in the raw material alloy is controlled such that the proportion of Al relative to R satisfies the requirement that the value of Al (atom %)/{(R (atom %)−12)+Al (atom %)} is in the range of 0.45 to 0.70.

In the above case, the content of R in the average composition of the R-T-B-based rare earth magnet particles according to the present invention is preferably not less than 13.8 atom % and not more than 17.0 atom %, and more preferably not less than 14.0 atom % and not more than 16.5 atom %.

In the above case, the content of Al in the average composition of the R-T-B-based rare earth magnet particles according to the present invention is preferably not less than 1.8 atom % and not more than 5.0 atom %, and more preferably not less than 2.0 atom % and not more than 4.5 atom %.

Also, in the above case, it is preferred that the content of R in the composition of the grain boundary phase of the R-T-B-based rare earth magnet particles according to the present invention is not less than 14.0 atom % and not more than 35.0 atom %, and the content of Al in the composition of the grain boundary phase is not less than 2.0 atom % and not more than 7.0 atom %. It is more preferred that the content of R in the composition of the grain boundary phase is not less than 20.0 atom % and not more than 33.0 atom %, and the content of Al in the composition of the grain boundary phase is not less than 2.2 atom % and not more than 6.0 atom %.

In the present invention, when the raw material alloy is subjected to dehydrogenation at a low velocity at a vacuum degree of not more than 2000 Pa in which hydrogen is dissociated from the R-rich phase at a relatively low temperature at which the R—Al liquid phase is present during the DR step, the resulting magnet particles can be enhanced in coercive force. In particular, when subjecting the raw material alloy comprising a large amount of R and Al to the above dehydrogenation at a low temperature and at a low velocity, the resulting magnet particles can be more highly enhanced in coercive force.

After completion of the complete evacuation step, the thus obtained magnet particles are cooled. When subjecting the magnet particles to rapid cooling in Ar, it is possible to prevent growth of crystal grains in the magnet particles.

Next, the bonded magnet according to the present invention is described.

The bonded magnet according to the present invention may be produced by molding a resin composition comprising the R-T-B-based rare earth magnet particles, a binder resin and other additives, and then subjecting the resulting molded product to magnetization.

The above resin composition comprises 85 to 99% by weight of the R-T-B-based rare earth magnet particles, and the balance comprising the binder resin and other additives.

The binder resin used in the resin composition for the bonded magnet may be selected from various resins depending upon the molding method used. In the case of an injection molding method, an extrusion molding method and a calender molding method, thermoplastic resins may be used as the binder resin. In the case of a compression molding method, thermosetting resins may be used as the binder resin. Examples of the thermoplastic resins used in the present invention include nylon (PA)-based resins, polypropylene (PP)-based resins, ethylene-vinyl acetate (EVA)-based resins, polyphenylene sulfide (PPS)-based resins, liquid crystal plastic (LCP)-based resins, elastomer-based resins and rubber-based resins. Examples of the thermosetting resins used in the present invention include epoxy-based resins and phenol-based resins.

Meanwhile, upon mixing the R-T-B-based rare earth magnet particles and the binder resin, in order to improve a fluidity and a moldability of the resin composition and attain sufficient magnetic properties of the resulting R-T-B-based rare earth magnet particles, the resin composition may also comprise, in addition to the binder resin, various known additives such as a plasticizer, a lubricant and a coupling agent, if required. Further, various other kinds of magnet particles such as ferrite magnet particles may also be mixed in the resin composition.

These additives may be adequately selected according to the aimed applications. As the plasticizer, commercially available products may be appropriately used according to the resins used. The total amount of the plasticizer added is about 0.01 to about 5.0% by weight based on the weight of the binder resin.

Examples of the lubricant used in the present invention include stearic acid and derivatives thereof, inorganic lubricants, oil-based lubricants. The lubricant may be used in an amount of about 0.01 to about 1.0% by weight based on a whole weight of the bonded magnet.

As the coupling agent, commercially available products may be used according to the resins and fillers used. The coupling agent may be used in an amount of about 0.01 to about 3.0% by weight based on the weight of the binder resin used.

As the other magnetic particles, there may be used ferrite magnet particles, Al—Ni—Co magnet particles, rare earth magnet particles or the like.

The mixing of the R-T-B-based rare earth magnet particles and the binder resin may be carried out using a mixing device such as a Henschel mixer, a V-shaped mixer and a Nauta mixer, whereas the kneading may be carried out using a single-screw kneader, a twin-screw kneader, a mill-type kneader, an extrusion kneader or the like.

The bonded magnet according to the present invention may be produced by mixing the R-T-B-based rare earth magnet particles and the binder resin, subjecting the resulting resin composition to a molding process by a known molding method such as an injection molding method, an extrusion molding method, a compression molding method or a calender molding method, and then subjecting the resulting molded product to electromagnet magnetization or pulse magnetization by an ordinary method to form the bonded magnet.

The magnetic properties of the bonded magnet may variously changed according to the aimed applications thereof. The bonded magnet preferably has a residual magnetic flux density of 350 to 900 mT (3.5 to 9.0 kG), a coercive force of 239 to 1750 kA/m (3000 to 22000 Oe), and a maximum energy product of 23.9 to 198.9 kJ/m³ (3 to 25 MGOe).

### EXAMPLES

In the following, the present invention is described in more detail by Examples and Comparative Examples.

In analysis of the average composition of the R-T-B-based rare earth magnet particles and the composition of the raw material alloy as described in the present invention, B and Al were analyzed using an ICP emission spectrophotometer “iCAP6000” manufactured by Thermo Fisher Scientific K.K., whereas the elements other than B and Al were analyzed using a fluorescent X-ray analyzer “RIX2011” manufactured by Rigaku Corporation.

The composition of the grain boundary of the particles was analyzed using an energy disperse type X-ray analyzer “JED-2300F” manufactured by JEOL Ltd.

As magnetic properties of the R-T-B-based rare earth magnet particles according to the present invention, a coercive force (H_{cj}), a maximum energy product ((BH)ₘₐₓ) and a residual magnetic flux density (Bᵣ) of the magnet particles were measured using a vibrating sample type magnetic flux meter (VSM: “VSM-5 Model”) manufactured by Toei Kogyo K.K.

### (Production of Raw Material Alloy Particles)

Alloy ingots Al to All each having a composition shown in Table 1 below were produced. The thus produced alloy ingots were subjected to heat treatment in a vacuum atmosphere at 1150° C. for 20 hr to obtain a homogenized composition. After completion of the homogenization heat treatment, the resulting particles were subjected to coarse pulverization using a jaw crusher, and further to hydrogen absorption and then mechanical pulverization, thereby obtaining raw material alloy particles A1 to A11.

TABLE 1

| | Composition of raw material alloy | | | | |
|---|---|---|---|---|---|
| | Nd | Fe | Co | B | Al |
| Kind | atom % | atom % | atom % | atom % | atom % |
| A1 | 13.5 | Bal. | 5.3 | 6.2 | 2.5 |
| A2 | 13.5 | Bal. | 5.3 | 6.2 | 1.5 |
| A3 | 12.9 | Bal. | 5.3 | 6.2 | 1.5 |
| A4 | 14.0 | Bal. | 5.3 | 6.2 | 2.5 |
| A5 | 12.9 | Bal. | 5.3 | 6.2 | 0 |
| A6 | 12.9 | Bal. | 5.3 | 6.2 | 0.5 |
| A7 | 13.5 | Bal. | 5.3 | 6.2 | 0.5 |
| A8 | 15.6 | Bal. | 5.3 | 6.2 | 2.6 |
| A9 | 12.9 | Bal. | 5.3 | 6.2 | 1.5 |
| A10 | 14.0 | Bal. | 5.3 | 6.2 | 2.0 |
| A11 | 12.9 | Bal. | 5.3 | 6.2 | 0 |

| | Composition of raw material alloy | | |
|---|---|---|---|
| | | | Al (atom %)/{(R (atom %) − |
| | Ga | Zr | 12) + Al (atom %)} |
| Kind | atom % | atom % | — |
| A1 | 0.5 | 0.1 | 0.63 |
| A2 | 0.5 | 0.1 | 0.50 |
| A3 | 0.5 | 0.1 | 0.63 |
| A4 | 0.5 | 0.1 | 0.56 |
| A5 | 0.5 | 0.1 | 0 |
| A6 | 0.5 | 0.1 | 0.36 |
| A7 | 0.5 | 0.1 | 0.25 |
| A8 | 0.5 | 0.1 | 0.42 |
| A9 | 0 | 0.1 | 0.63 |
| A10 | 0.5 | 0 | 0.50 |
| A11 | 0 | 0.1 | 0 |

### Example 1

### HDDR Treatment

### HD Step

In the HD step, 5 kg of the raw material alloy particles A1 were charged into a furnace. Thereafter, the particles were heated to 840° C. in a mixed gas of hydrogen and Ar maintained under a total pressure of 100 kPa (atmospheric pressure) having a hydrogen partial pressure of 60 kPa and held therein for 200 min.

### (HDDR Treatment: Preliminary Evacuation Step)

After completion of the HD step, the resulting particles were subjected to a preliminary evacuation step in which an inside of the furnace was evacuated using a rotary pump until the vacuum degree inside of the furnace reached 3.2 kPa. By controlling a valve opening degree of the vacuum evacuation system, the vacuum degree inside of the furnace was held under 3.2 kPa at a temperature of 840° C. for 100 min to subject the particles to dehydrogenation.

### (HDDR Treatment: Complete Evacuation Step)

After completion of the preliminary evacuation step, the resulting particles were further subjected to a complete evacuation step in which the vacuum evacuation was further continued until the vacuum degree inside of the furnace was dropped from 3.2 kPa and finally reached not more than 1 Pa. The complete evacuation step was conducted at a treating temperature of 840° C. for a total treating time of 90 min among which the retention time at a vacuum degree of not less than 1 Pa and not more than 2000 Pa was 50 min to remove hydrogen remaining in the particles. The resulting particles were cooled to obtain R-T-B-based rare earth magnet particles. The thus obtained R-T-B-based rare earth magnet particles had an average composition similar to the composition of the raw material alloy.

### Example 2

The HDDR treatment was conducted in the same manner as in Example 1 except for using the raw material alloy A2, thereby obtaining R-T-B-based rare earth magnet particles.

### Example 3

The procedure up to the preliminary evacuation step of the HDDR treatment was conducted in the same manner as in Example 1 except for using the raw material alloy A2. Thereafter, the complete evacuation step was conducted at a treating time of 840° C. for a total treating time of 45 min among which the retention time at a vacuum degree of not less than 1 Pa and not more than 2000 Pa was 15 min to remove hydrogen remaining in the particles. The resulting particles were cooled to obtain R-T-B-based rare earth magnet particles.

### Example 4

The HDDR treatment was conducted in the same manner as in Example 1 except for using the raw material alloy A3, thereby obtaining R-T-B-based rare earth magnet particles.

### Example 5

The HDDR treatment was conducted in the same manner as in Example 1 except for using the raw material alloy A4, thereby obtaining R-T-B-based rare earth magnet particles.

### Example 6

The HDDR treatment was conducted in the same manner as in Example 1 except for using the raw material alloy A8, thereby obtaining R-T-B-based rare earth magnet particles.

### Example 7

The HDDR treatment was conducted in the same manner as in Example 1 except that the raw material alloy A3 was used, and the complete evacuation step was conducted at a temperature of 725° C. for a treating time of 160 min among which the retention time at a vacuum degree of not more than 2000 Pa was 120 min, thereby obtaining R-T-B-based rare earth magnet particles.

### Example 8

The HDDR treatment was conducted in the same manner as in Example 7 except for using the raw material alloy A4, thereby obtaining R-T-B-based rare earth magnet particles.

### Example 9

The HDDR treatment was conducted in the same manner as in Example 7 except for using the raw material alloy A8, thereby obtaining R-T-B-based rare earth magnet particles.

### Example 10

The HDDR treatment was conducted in the same manner as in Example 1 except for using the raw material alloy A9, thereby obtaining R-T-B-based rare earth magnet particles.

### Example 11

The HDDR treatment was conducted in the same manner as in Example 1 except for using the raw material alloy A10, thereby obtaining R-T-B-based rare earth magnet particles.

### Comparative Example 1

The HDDR treatment was conducted in the same manner as in Example 1 except for using the raw material alloy A5, thereby obtaining R-T-B-based rare earth magnet particles.

### Comparative Example 2

The HDDR treatment was conducted in the same manner as in Example 3 except for using the raw material alloy A5, thereby obtaining R-T-B-based rare earth magnet particles.

### Comparative Example 3

The HDDR treatment was conducted in the same manner as in Example 3 except for using the raw material alloy A6, thereby obtaining R-T-B-based rare earth magnet particles.

### Comparative Example 4

The HDDR treatment was conducted in the same manner as in Example 3 except for using the raw material alloy A7, thereby obtaining R-T-B-based rare earth magnet particles.

### Comparative Example 5

The HDDR treatment was conducted in the same manner as in Example 1 except for using the raw material alloy A11, thereby obtaining R-T-B-based rare earth magnet particles.

TABLE 2

| | | Complete evacuation step | | |
|---|---|---|---|---|
| | | | Retention | |
| Examples and | Alloy | Total | time at 1 | |
| Comparative | used | time | to 2000 Pa | Temperature |
| Examples | Kind | min | min | ° C. |
| Example 1 | A1 | 90 | 50 | 840 |
| Example 2 | A2 | 90 | 50 | 840 |
| Example 3 | A2 | 45 | 15 | 840 |
| Example 4 | A3 | 90 | 50 | 840 |
| Example 5 | A4 | 90 | 50 | 840 |
| Example 6 | A8 | 90 | 50 | 840 |
| Example 7 | A3 | 160 | 120 | 725 |
| Example 8 | A4 | 160 | 120 | 725 |
| Example 9 | A8 | 160 | 120 | 725 |
| Example 10 | A9 | 90 | 50 | 840 |
| Example 11 | A10 | 90 | 50 | 840 |
| Comparative | A5 | 90 | 50 | 840 |
| Example 1 | | | | |
| Comparative | A5 | 45 | 15 | 840 |
| Example 2 | | | | |
| Comparative | A6 | 45 | 15 | 840 |
| Example 3 | | | | |
| Comparative | A7 | 45 | 15 | 840 |
| Example 4 | | | | |
| Comparative | A11 | 90 | 50 | 840 |
| Example 5 | | | | |

| | Average composition | | Composition of grain | |
|---|---|---|---|---|
| | of particles | | boundary | |
| Examples and | Al | Nd | Al | Nd |
| Comparative | content | content | content | content |
| Examples | atom % | atom % | atom % | atom % |
| Example 1 | 2.5 | 13.5 | 3.13 | 27.2 |
| Example 2 | 1.5 | 13.5 | 1.72 | 27.5 |
| Example 3 | 1.5 | 13.5 | 1.72 | 27.5 |
| Example 4 | 1.5 | 12.9 | 1.73 | 23.7 |
| Example 5 | 2.5 | 14.0 | 3.05 | 26.5 |
| Example 6 | 2.6 | 15.6 | 3.45 | 30.6 |
| Example 7 | 1.5 | 12.9 | 1.73 | 23.7 |
| Example 8 | 2.5 | 14.0 | 3.05 | 26.5 |
| Example 9 | 2.6 | 15.6 | 3.47 | 30.7 |
| Example 10 | 1.5 | 12.9 | 3.13 | 27.2 |
| Example 11 | 2.0 | 14.0 | 1.75 | 28.4 |
| Comparative | 0 | 12.9 | 0 | 21.4 |
| Example 1 | | | | |
| Comparative | 0 | 12.9 | 0 | 21.4 |
| Example 2 | | | | |
| Comparative | 0.5 | 12.9 | 0.49 | 24.0 |
| Example 3 | | | | |
| Comparative | 0.5 | 13.5 | 0.56 | 26.2 |
| Example 4 | | | | |
| Comparative | 0 | 12.9 | 0 | 20.4 |
| Example 5 | | | | |

| Examples and | Magnetic properties | | |
|---|---|---|---|
| Comparative | H_{cj} | (BH)ₘₐₓ | Br |
| Examples | kA/m | kJ/m³ | T |
| Example 1 | 1520 | 238 | 1.18 |
| Example 2 | 1480 | 247 | 1.19 |
| Example 3 | 1430 | 230 | 1.18 |
| Example 4 | 1380 | 265 | 1.22 |
| Example 5 | 1550 | 230 | 1.17 |
| Example 6 | 1560 | 210 | 1.08 |
| Example 7 | 1430 | 266 | 1.21 |
| Example 8 | 1630 | 231 | 1.15 |
| Example 9 | 1750 | 215 | 1.08 |
| Example 10 | 1000 | 225 | 1.18 |
| Example 11 | 1570 | 197 | 1.05 |
| Comparative | 1100 | 290 | 1.25 |
| Example 1 | | | |
| Comparative | 1100 | 290 | 1.25 |
| Example 2 | | | |
| Comparative | 1150 | 280 | 1.24 |
| Example 3 | | | |
| Comparative | 1170 | 275 | 1.23 |
| Example 4 | | | |
| Comparative | 570 | 200 | 1.19 |
| Example 5 | | | |

### (Results)

As shown in Table 2, the magnet particles obtained in Examples 1 to 9 and 11 had a coercive of not less than 1300 kA/m. In particular, the magnet particles obtained in Examples 1, 5, 6, 8, 9 and 11 had a high coercive force of not less than 1500 kA/m. The reason therefor is considered to be that since the complete evacuation step was conducted for a sufficient period of time, the Nd-rich phase was diffused in the grain boundary. In addition, in Examples 7 to 9 in which the complete evacuation step was conducted at a low temperature and at a low velocity, the magnet particles obtained therein had a higher coercive force. In particular, in Example 9 in which the raw material alloy comprising a large amount of Nd and Al was used and the dehydrogenation was conducted at a low temperature and at a low velocity, the large effect of enhancing a coercive force of the resulting magnet particle was attained.

In Example 10 using no Ga, the obtained magnet particles exhibited a low coercive force value, but the effect of enhancing a coercive force thereof was recognized by addition of Al as compared to Comparative Example 5.

In Example 11 using no Zr, the obtained magnet particles exhibited a low residual magnetic flux density value, but the effect of enhancing a coercive force thereof was recognized by addition of Al.

In Comparative Examples 1 to 5 in which no Al or a less amount of Al was added, the obtained magnet particles failed to exhibit a sufficient coercive force. In the present invention, Nd—Al was melted at a temperature of about 630° C., and the Nd-rich phase was likely to be diffused in the grain boundary. However, if Al is not present in a sufficient amount, Nd was hardly melted at the HDDR treatment temperature. As a result, it was considered that in these Comparative Examples, the Nd-rich phase was hardly diffused in the grain boundary, so that the magnet particles obtained therein failed to exhibit excellent magnetic properties.

In addition, from the comparison between Comparative Examples 1 and 2, even in the case where the retention time of the complete evacuation step at a vacuum degree of not less than 1 Pa and not more than 2000 Pa was prolonged, the obtained magnet particles was not enhanced in coercive force thereof. In the present invention, surplus Nd and Al were allowed to coexist in a predetermined amount or more to melt the Nd—Al during the HDDR treatment, and further the complete evacuation step is held at a vacuum degree of not less than 1 Pa and not more than 2000 Pa to conduct the dehydrogenation at a low velocity, so that diffusion of the Nd-rich phase in the grain boundary was promoted.

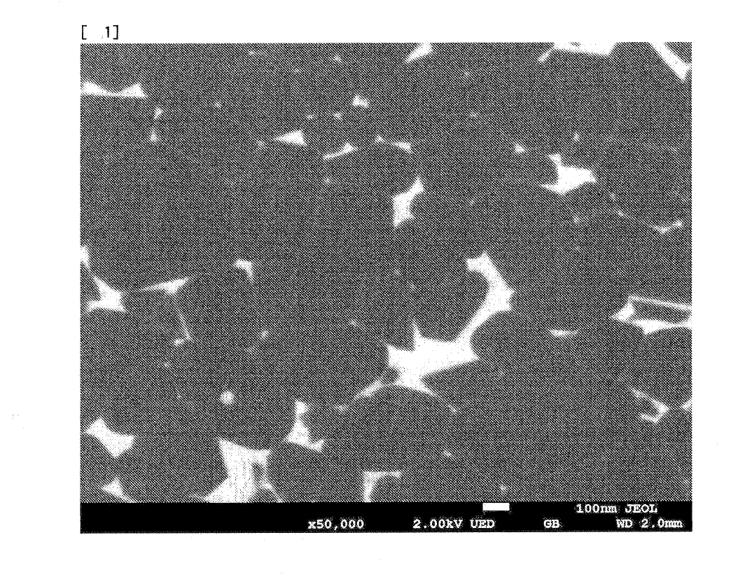

FIG. 1 shows an electron micrograph of the Nd—Fe—B-based rare earth magnet particles obtained in Example 1. In FIG. 1, black portions represent crystal grains, whereas white portions represent Nd-rich phases comprising a large amount of Nd as compared to the crystal grains. The Nd-rich phases in the magnet particles obtained in Example 1 had a composition comprising Al in an amount of 3.13 atom % and Nd in an amount of 27.2 atom %. From the micrograph, it was recognized that a continuous grain boundary phase was formed in an interface between the crystal grains.

### INDUSTRIAL APPLICABILITY

In accordance with the present invention, by controlling a composition of a grain boundary present between main phases to weaken a magnetic bond between the main phases, it was possible to obtain R-T-B-based rare earth magnet particles having an excellent coercive force. In addition, in the process for producing R-T-B-based rare earth magnet particles according to the present invention, it is possible to produce the R-T-B-based rare earth magnet particles having an excellent coercive force without using expensive rare sources such as Dy and conducting any additional steps other than the HDDR step.

1. R-T-B-based rare earth magnet particles comprising R (wherein R represents at least one rare earth element including Y), T (wherein T represents Fe, or Fe and Co), B (wherein B represents boron) and Al (wherein Al represents aluminum), and having an average composition comprising R in an amount of not less than 12.5 atom % and not more than 17.0 atom %, B in an amount of not less than 4.5 atom % and not more than 7.5 atom % and Al in an amount of not less than 1.0 atom % and not more than 5.0 atom %, in which the R-T-B-based rare earth magnet particles comprise crystal grains comprising a magnetic phase of R₂T₁₄B, and a grain boundary phase, and the grain boundary phase comprises R (wherein R represents at least one rare earth element including Y), T (wherein T represents Fe, or Fe and Co), B (wherein B represents boron) and Al (wherein Al represents aluminum), and has a composition comprising R in an amount of not less than 13.5 atom % and not more than 35.0 atom % and Al in an amount of not less than 1.0 atom % and not more than 7.0 atom %.

2. The R-T-B-based rare earth magnet particles according to claim 1, wherein the R-T-B-based rare earth magnet particles comprise Ga and Zr, and have a composition comprising Co in an amount of not more than 15.0 atom %, Ga in an amount of not less than 0.1 atom % and not more than 0.6 atom % and Zr in an amount of not less than 0.05 atom % and not more than 0.15 atom %.

3. A process for producing R-T-B-based rare earth magnet particles by HDDR treatment, in which a raw material alloy for the R-T-B-based rare earth magnet particles comprises R (wherein R represents at least one rare earth element including Y), T (wherein T represents Fe, or Fe and Co), B (wherein B represents boron) and Al (wherein Al represents aluminum), and has a composition comprising R in an amount of not less than 12.5 atom % and not more than 17.0 atom %, B in an amount of not less than 4.5 atom % and not more than 7.5 atom %, and Al in such an amount that a proportion of Al relative to R satisfies a requirement that a value of Al (atom %)/{(R (atom %)−12)+Al (atom %)} falls with the range of 0.40 to 0.75; the DR step of the HDDR treatment is conducted at a treating temperature of 650 to 900° C.; and a retention time of an evacuation step in the DR step at a vacuum degree of not less than 1 Pa and not more than 2000 Pa is not less than 10 min and not more than 300 min, the vacuum degree to be finally reached being not more than 1 Pa.

4. The process for producing R-T-B-based rare earth magnet particles according to claim 3, wherein the raw material alloy comprises Ga and Zr, and has a composition comprising Co in an amount of not more than 15.0 atom %, Ga in an amount of not less than 0.1 atom % and not more than 0.6 atom % and Zr in an amount of not less than 0.05 atom % and not more than 0.15 atom %.

5. A bonded magnet comprising the R-T-B-based rare earth magnet particles as defined in claim 1.
